(19) United States
(12) Patent Application Publication
(10) Pub. No.: US 2010/0319665 A1
(43) Pub. Date: Dec. 23, 2010

(54) Fuel-air separation structure improvement for engine blow-by of vehicles

(75) Inventors: Tony Li, Tainan Hsien (TW); Hui-Hui Huang, Tainan Hsien (TW)

Correspondence Address: BACON & THOMAS, PLLC, 625 SLATERS LANE, FOURTH FLOOR, ALEXANDRIA, VA, 22314-1176, US

(73) Assignee: Aeon Motor Co., Ltd., Tainan Hsien (TW)

(21) Appl. No.: 12/457,660

(22) Filed: Jun. 18, 2009

(51) Int. Cl. F02B 25/06

(52) U.S. Cl. 123/573; 123/574

(57) ABSTRACT

This invention is to provide a fuel-air separation structure improvement for engine blow-by, which features an extra oil recirculation tube set up in between the bottom of the fuel-air separator and the engine, where the flow connection of the oil recirculation tube is controlled by a check valve, and the direction of the check valve is enabled only in a unidirectional way, pointing from the fuel-air separator to the crankcase of the engine, whereas the reverse direction is being cut off. By means of the aforementioned structure, the problems of carbon deposits in engine and exhaust pollution due to an excess of oil along with blow-by in the fuel-air separator can thus be substantially improved.

### BACKGROUND OF THE INVENTION

1. Field of the Invention This invention relates generally to a fuel-air separation structure improvement for engine blow-by of vehicles and more particularly to one that is able to improve the blow-by along with an excess of oil into the fuel-air separator that makes it fail to work, to avoid the derived air pollution and the increasing carbon deposits, and to abate the efficiency of the engine.

2. Description of the Prior Art

On the power stroke of the piston of an engine, an unburned mixture of gases slip through between cylinder wall and piston rings into the crankcase to form blow-by gases. For environmental protection sake, the unburned mixture of gases is redirected, instead of discharge, to the fuel-air separator for the separation of fuel and air, followed by burning in the combustion chamber, which is aimed at leveling down air pollution. To conduct the mixture of gases into the combustion chamber for burning, there are two approaches in the prior art which are shown in FIGS. 1 & 2. On the power stroke of the piston, the blow-by escapes past between the piston rings and cylinder wall, while on the intake and power strokes of the piston, the piston 11 moves toward the crankcase 10, compresses the dimensions of the crankcase 10, to enable the crankcase 10 to form a positive pressure. Due to the interlinking of the interiors of the crankcase 10 and cylinder head cover 12, the interior of the cylinder head cover 12 is therefore formed a positive pressure. At the moment, the blow-by along with the oil in the crankcase 10 flow through a blow-by tube 13 to the fuel-air separator 14 for the separation of fuel and air. After separation, air flows through a blow-by recirculation tube 15 back to an air filter 17 for burning, instead of discharge to bring about pollutions to the atmosphere. FIG. 1 shows a prior art approach, where the separated oil is accumulated in a preserved tube 16, which is for leaking out once a predetermined amount is reached. The other approach shown in FIG. 2 doesn't provide with a preserved tube. And this approach only works provided that the oil along with the blow-by is less. Otherwise, an excess of oil along with blow-by would flow into the air filter 17. As engine deteriorates, the amount of blow-by that occurs can increase. In addition, once engine is mounted on a vehicle (for instance: all terrain vehicles, off road vehicles, etc.), it usually has sizable jolts. And consequently the blow-by is often discharged with excessive oil. As the oil in the reserved tube of the fuel-air separator is full but not leaking out yet, the separator 14 will suffer too much oil and fail to function the separation, where the excess of oil flows through the separator 14 and the blow-by recirculation tube 15 into the air filter 17, which would feed excessive oil along with fresh air into the combustion chamber for burning during the intake stroke, and the incomplete combustion brings in pollutions to the atmosphere. An excess of oil burning in the combustion chamber will lead to much soot and deposits left over in the chamber that will deteriorate the engine causing great damage.

### SUMMARY OF THE INVENTION

In the light of the aforementioned drawbacks of the prior art fuel-air separation for engine blow-by of vehicles, this inventor conceived the idea for the advanced improvement, and eventually the endeavors gave birth to this invention.

The objective of the present invention is to provide a fuel-air separation structure improvement for engine blow-by of vehicles that is able to avoid an excess of oil along with blow-by into the combustion chamber for burning, which brings about air pollutions and carbon deposits in engine, and abates dramatically the lifetime of the engine.

The main traits of the present invention lie in: an oil recirculation tube is additionally set up in between the bottom of the fuel-air separator and the engine, where the flow connection of the oil recirculation tube is controlled by a check valve, and the direction of the check valve is enabled only in a unidirectional way which is from the fuel-air separator to the crankcase of the engine, whereas the reverse direction is being cut off. With the integral effects out of the features of the check valve, fuel-air separator and the oil recirculation tube, the problems of carbon deposits in engine and exhaust pollution due to an excess of oil along with blow-by in the fuel-air separator can thus be improved. And the oil can be recycled to the crankcase after the separation of blow-by, which could simplify matters of watching out the liquid height of the oil preserved tube.

### BRIEF DESCRIPTION OF THE DRAWINGS

FIG. 1 is a diagram of fuel-air separation structural for engine blow-by of the prior art (I.);

FIG. 2 is a diagram of fuel-air separation structural for engine blow-by of the prior art (II.);

FIG. 3 is a diagram of fuel-air separation structural improvement for engine blow-by of the first exemplary embodiment of this invention;

FIG. 4 is a diagram of fuel-air separation structural improvement for engine blow-by of the second exemplary embodiment of this invention;

FIG. 5 is a diagram (connected state) of the reed type of the check valve structure which is an exemplary embodiment of the check valve of this invention;

FIG. 6 is a diagram (disconnected state) of the reed type of the check valve structure which is an exemplary embodiment of the check valve of this invention;

FIG. 7 is a diagram (connected state) of the steel ball spring type of the check valve structure which is an exemplary embodiment of the check valve of this invention; and

FIG. 8 is a diagram (disconnected state) of the steel ball spring type of the check valve structure which is an exemplary embodiment of the check valve of this invention.

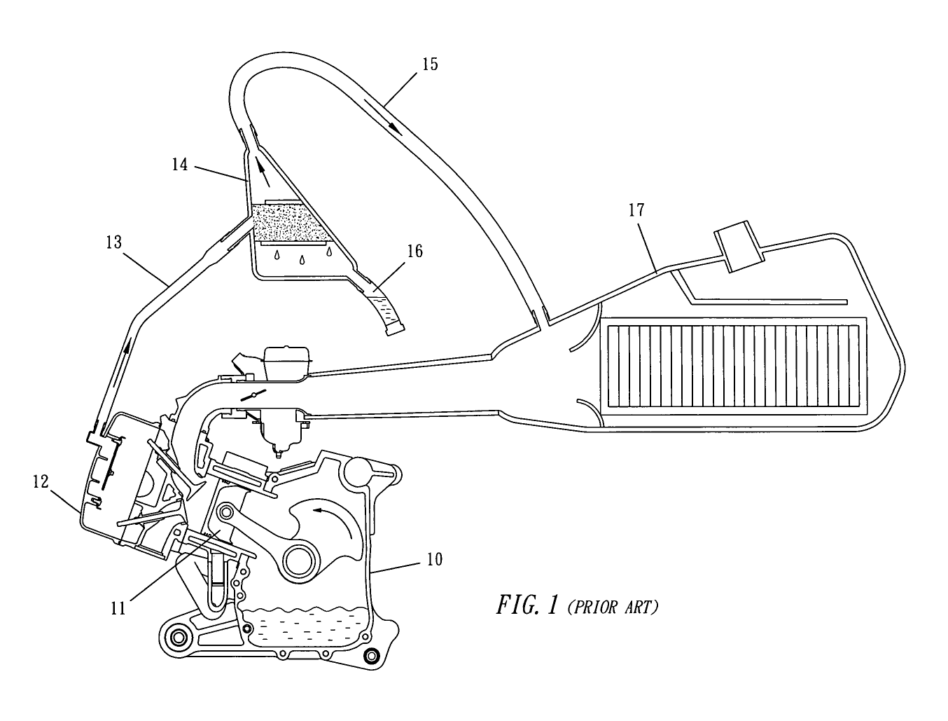

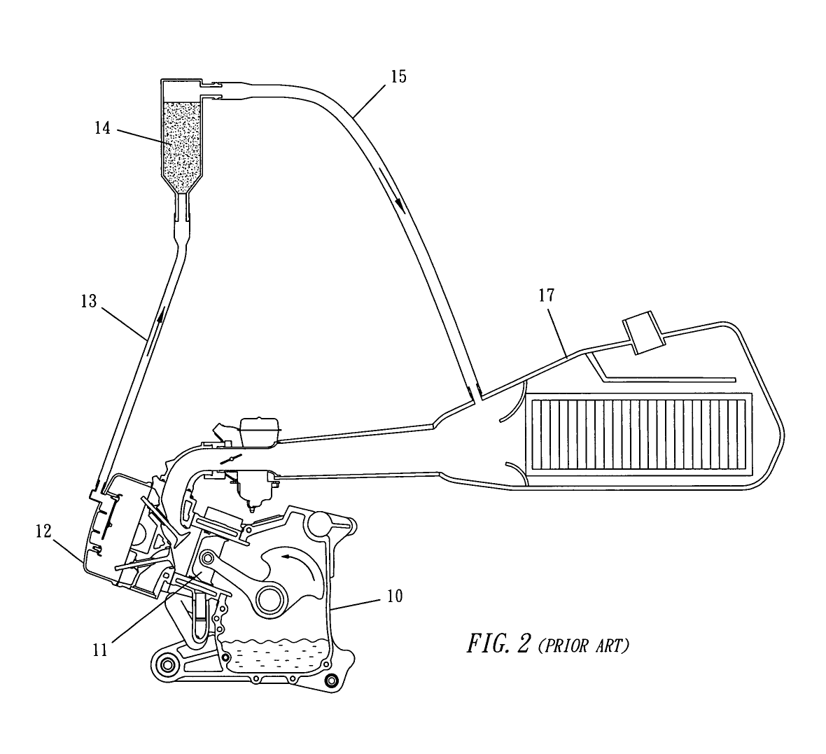

### DETAILED DESCRIPTION OF THE INVENTION

To achieve the foregoing objects and function of the present invention, the techniques and structure adopted are described with reference to the following preferred embodiments.

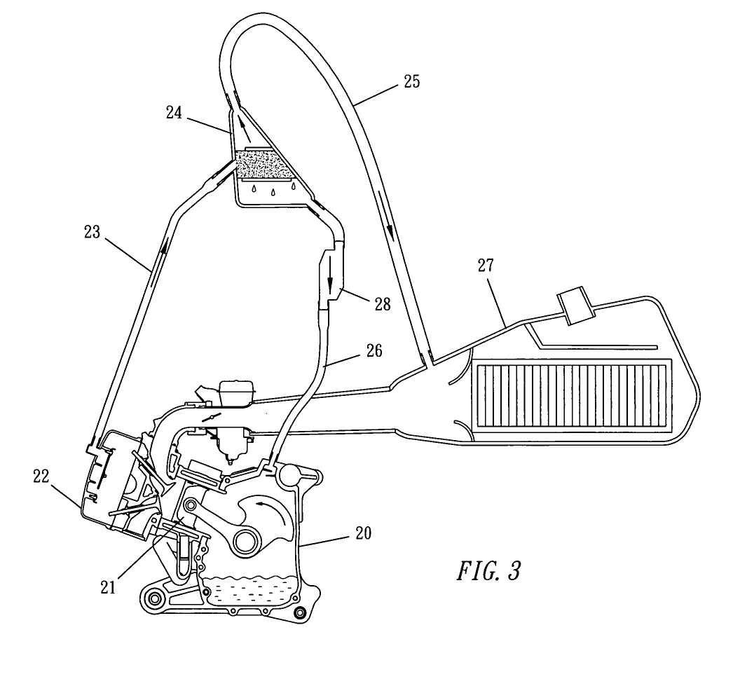

Referring to FIG. 3, this invention is just like prior art, where the interiors of crankcase 20 and cylinder head cover 22 of the engine are interlinked to each other. And a blow-by tube 23 is set up in between the interior of the cylinder head cover 22 and a fuel-air separator 24, where blow-by is reflowed to an air filter 27 through a blow-by recirculation tube 25 after the separation by the fuel-air separator 24. Unlike the prior art oil recirculation tube 26 set up in between the bottom of the fuel-air separator 24 and the crankcase 20 of the engine, the flow connection of the oil recirculation tube 26 is controlled by a check valve 28, and the direction of the check valve 28 is enabled only in a unidirectional way which is from the fuel-air separator 24 to the crankcase 20 of the engine, whereas the reverse direction is being cut off. This means the use of the check valve 28 enables the connection pointing from the fuel-air separator 24 to the crankcase 20, whereas disables the connection pointing from the crankcase 20 to the fuel-air separator 24, which further enables the oil to reflow back to the crankcase 20 through the oil recirculation tube 26 and the check valve 28 after the separation by the fuel-air separator 24, while the blow-by is not allowed to pass through the oil recirculation tube 26 to the fuel-air separator 24. On the power stroke of the piston, partial unburned mixture of gases will slip in between piston rings and the wall of the cylinder to the crankcase 20 due to the high pressure in the combustion chamber. And on the intake or power stroke stage, the piston 21 moves toward the crankcase 20, compresses the dimensions of the crankcase 20, to enable the crankcase 20 to form a positive pressure. Since the interiors of the crankcase 20 and the cylinder head cover 22 are interlinked, the blow-by along with the oil in the crankcase 20 flow from the interior of the cylinder head cover 22 through the blow-by tube 23 to the fuel-air separator 24 for the separation of fuel and air. After separation, the oil is temporarily stored in the fuel-air separator 24, while the blow-by flows through the blow-by recirculation tube 25 back to the air filter 27 for burning. At the moment, due to the positive pressure of the crankcase 20 and the closure of the check valve 28, the blow-by is not able to flow through the oil recirculation tube 26 to the fuel-air separator 24. On the compression or exhaust stroke of the piston, the piston 21 moves toward combustion chamber, expands the dimensions of the crankcase 20 to enable the crankcase 20 to form a negative pressure. The negative pressure of the crankcase 20 enables the opening of the check valve 28, which further makes the oil temporarily stored in the fuel-air separator 24 to flow back to the crankcase 20 through the oil recirculation tube 26 and the check valve 28. And the oil after the separation is available for recirculation and reusing.

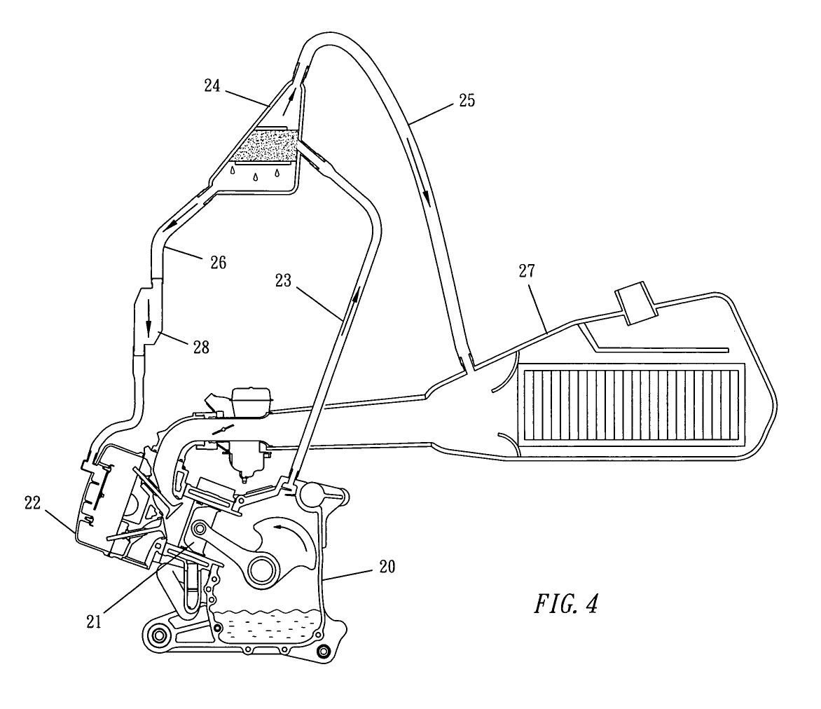

Since the interiors of the crankcase 20 and the cylinder head cover 22 are interlinked to each other, the oil recirculation tube 26 with the check valve 28 can be set up in between the bottom of the fuel-air separator 24 and the cylinder head cover 22 shown in FIG. 4. The direction of the check valve 28 is enabled only in a unidirectional way which is from the fuel-air separator 24 to the crankcase 20 of the engine, whereas the reverse direction is being cut off. Blow-by flows from the crankcase 20 to the fuel-air separator 24 for fuel and air separation, and the oil flows through the check valve 28 and the oil recirculation tube 26 into the cylinder head cover 22 (in the engine). The configuration of the check valve 28 and the oil recirculation tube 26 of the exemplary embodiments shown in FIGS. 3 & 4 are functioning the same.

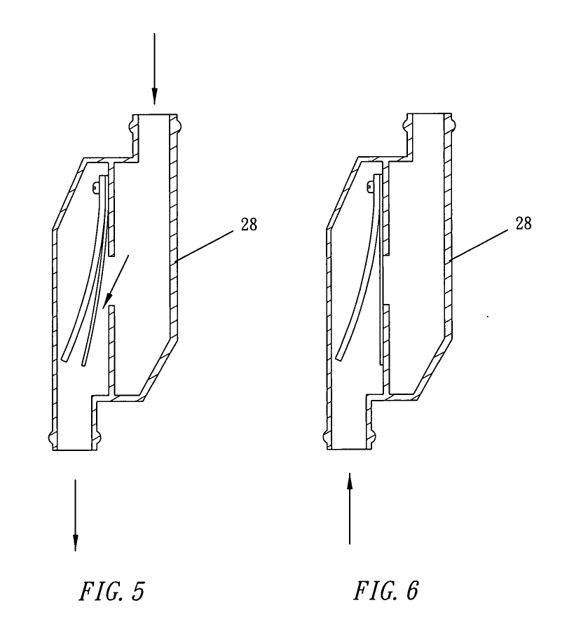

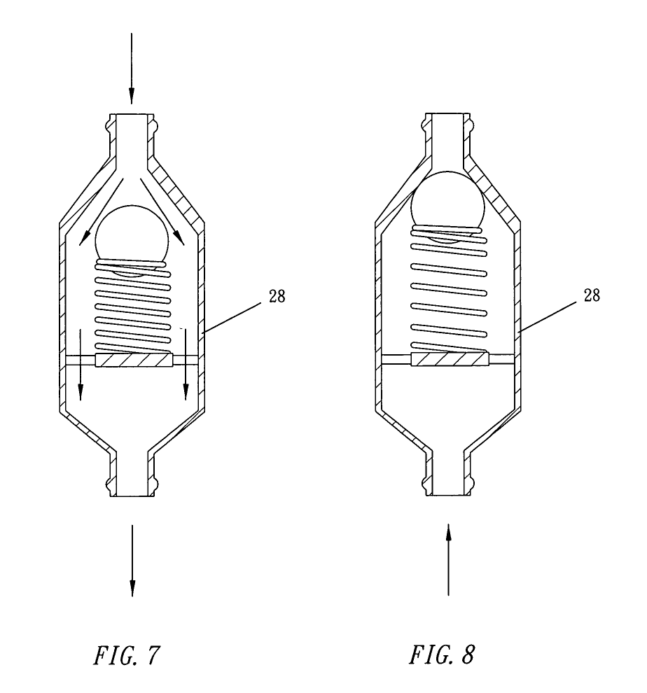

The structure of the check valve 28 could be the reed type of the check valve 28 shown in FIGS. 5 & 6, or the steel ball spring type of the check valve 28. Both are available for the unidirectional connection.

To sum up, the present invention is construed as not only novel but useful and creative, thereby filing the present application herein subject to the patent law, which may obtain a patent thereof.

What is claimed is:

1. A fuel-air separation structure improvement for engine blow-by of vehicles, having a blow-by tube in between the engine and fuel-air separator, where the fuel-air separator joins a blow-by recirculation tube at its output to an air filter for the recirculation of blow-by gases, the improvement comprising:
an extra oil recirculation tube being set up in between the bottom of the fuel-air separator and the engine, where the flow connection of the oil recirculation tube is controlled by a check valve, and the direction of the check valve being enabled only in a unidirectional way, pointing from the fuel-air separator to the engine, whereas the reverse direction is being cut off, such that blow-by gases being unable to enter the fuel-air separator through the oil recirculation tube, provided that the engine being in positive pressure and a check valve being closed, while the oil flows back to engine through the oil recirculation tube after the separation by the fuel-air separator, provided that the engine being in negative pressure and the check valve being opened.

2. A fuel-air separation structure improvement for engine blow-by of vehicles as in claim 1 wherein the joining of the oil recirculation tube and the engine is connected to crankcase of the engine.

3. A fuel-air separation structure improvement for engine blow-by of vehicles as in claim 1 wherein the joining of the oil recirculation tube and the engine is connected to cylinder head cover of the engine.

4. A fuel-air separation structure improvement for engine blow-by of vehicles as in claim 1 wherein the check valve is a reed type.

5. A fuel-air separation structure improvement for engine blow-by of vehicles as in claim 1 wherein the check valve is a steel ball spring type.
